(19) United States
(12) Patent Application Publication
(10) Pub. No.: US 2026/0267919 A1
(43) Pub. Date: Sep. 10, 2026

(54) GRAPH DATABASE SYSTEM AND GRAPH QUERY METHOD

(71) Applicant: Alipay (Hangzhou) Digital Service Technology Co., Ltd., Hangzhou (CN)

(72) Inventors: Zigang ZHANG, Hangzhou (CN); Ruoyan Ma, Hangzhou (CN); Chuntao Hong, Hangzhou (CN)

(21) Appl. No.: 19/551,511

(22) Filed: Feb. 26, 2026

(30) Foreign Application Priority Data
Mar. 7, 2025 (CN) 202510278070.1
Mar. 7, 2025 (CN) 202510281232.7

(51) Int. Cl. G06F 16/901; G06F 16/903

(52) U.S. Cl. CPC G06F 16/9024; G06F 16/90335

(57) ABSTRACT

One or more implementations of the present application provide a graph database system and a graph query method. A node and an edge in a graph are represented by a key-value pair, and are stored in an SSTable file; the SSTable file includes a first data block and a second data block; an edge attribute is stored in the second data block; in a first key-value pair, a key includes a node identifier, and a value includes a node attribute; in a second key-value pair, a key includes a start identifier and a destination identifier of the edge, and a value includes storage location information of the edge attribute; and a first key-value pair and a second key-value pair that have the same node identifier and the same start identifier of the edge are aggregated and stored in the first data block. The method includes: obtaining a target key; querying the SSTable file based on a target node identifier in the target key, to determine a target first data block used to aggregate and store a key-value pair including the target node identifier; querying the target first data block based on the target key, to determine a target value corresponding to the target key; and determining a graph query result based on the target value.

### TECHNICAL FIELD

One or more implementations of the present application relate to the field of storage system technologies, and in particular, to a graph database system and a graph query method.

### BACKGROUND

A graph is a data structure, and stores and manages data in a graph form. In the graph, nodes, edges, and properties are used to store the data. Such a storage manner is very suitable to express complex relationships between entities. In the graph, the nodes represent entities such as persons, locations, and events. Each node can have a plurality of attributes to describe information of an entity. The edge is used to represent a relationship between nodes, for example, “know”, “belong”, or “located”. The edge can also include attributes to describe characteristics of the relationship, for example, strength and an establishment time of the relationship. The attribute is a data field attached to the node or the edge, and is used to store information, for example, a name and an age of a person, or the strength and the establishment time of the relationship.

The graph is very suitable to express and process data with a complex relationship, and therefore, can usually provide relatively efficient query performance. Correspondingly, for files used to store graph data such as the nodes, the edges, and the attributes, the following has become a highly concerned problem: how to design a format of such files, so that such files are graph-aware, thereby maintaining original relatively efficient query performance of the graph, and improving efficiency of performing a graph query in such files.

### SUMMARY

One or more implementations of the present application provide some technical solutions:

The present application provides a graph database system. The graph database system is used to store graph data, and the graph data includes nodes and edges.

A storage space of the graph database system has a sorted string table (SSTable) file stored therein, the SSTable file includes at least one first data block used to store a key-value pair corresponding to the node and the edge, and a second data block used to store an edge attribute of the edge.

The key-value pair includes a first key-value pair and a second key-value pair; in the first key-value pair, a key includes a node identifier of a node, and a value includes a node attribute of the node; and in the second key-value pair, a key includes a start identifier and a destination identifier of an edge, and a value includes storage location information of the edge attribute of the edge in the SSTable file.

The first data block aggregates and stores a target first key-value pair, and a target second key-value pair whose start identifier is the same as a node identifier in the target first key-value pair.

The present application further provides a graph query method. A node and an edge in a graph are stored in a sorted string table (SSTable) file; the SSTable file includes at least one first data block used to store a key-value pair corresponding to the node and the edge, and a second data block used to store an edge attribute of the edge; the node and the edge are respectively represented by a first key-value pair and a second key-value pair, and are stored in the first data block; in the first key-value pair, a key includes a node identifier of the node, and a value includes a node attribute of the node; in the second key-value pair, a key includes a start identifier and a destination identifier of the edge, and a value includes storage location information of the edge attribute of the edge in the SSTable file; and each target first key-value pair, and a target second key-value pair whose start identifier is the same as a node identifier in the target first key-value pair are aggregated and stored in the first data block.

The method includes: obtaining a target key used to query the graph; querying the SSTable file based on a target node identifier in the target key, to determine a target first data block used to aggregate and store a first key-value pair and a second key-value pair that include the target node identifier; querying the target first data block based on the target key, to determine a target value corresponding to the target key; and determining the node attribute as a graph query result in response to the target value being the node attribute; or in response to the target value being the storage location information, based on the storage location information, determining an edge attribute corresponding to the target key in the second data block included in the SSTable file, and determining the edge attribute corresponding to the target key as a graph query result.

The present application further provides an electronic device, including: a processor; and a storage, configured to store processor-executable instructions.

The processor runs the executable instructions to implement the steps of the method according to any one of the above items.

The present application further provides a computer-readable storage medium. The computer-readable storage medium stores computer instructions, and the instructions are executed by a processor to implement the steps of the method according to any one of the above items.

In the above technical solutions, a node and an edge in a graph can be stored in an SSTable file; the SSTable file can include at least one first data block used to store a key-value pair corresponding to the node and the edge, and a second data block used to store an edge attribute of the edge; the node and the edge can be respectively represented by a first key-value pair and a second key-value pair, and be stored in the first data block; in a first key-value pair corresponding to a node, a key can include a node identifier of the node, and a value can include a node attribute of the node; in a second key-value pair corresponding to an edge, a key can include a start identifier and a destination identifier of the edge, and a value can include storage location information of the edge attribute of the edge in the SSTable file; and each target first key-value pair, and a target second key-value pair whose start identifier is the same as a node identifier in the target first key-value pair can be aggregated and stored in the first data block. Correspondingly, when a target key used to query the graph is obtained, the SSTable file can be queried based on a target node identifier in the target key, to determine a target first data block used to aggregate and store a first key-value pair and a second key-value pair that include the target node identifier; then the target first data block is queried based on the target key, to determine a target value corresponding to the target key; and the node attribute can be determined as a graph query result in response to the target value being the node attribute; or in response to the target value being the storage location information, based on the storage location information, an edge attribute corresponding to the target key can be determined in the second data block included in the SSTable file, and the edge attribute corresponding to the target key can be determined as a graph query result.

According to the above manner, a key-value storage system is improved by using characteristics of a graph topology and a graph query. For example, the key-value storage system is adjusted and improved in terms of a format of the SSTable file, an indexing manner, etc., so that the SSTable file used to store graph data in the key-value storage system is graph-aware. This can reduce complexity of a graph query operation, in the key-value storage system, of a graph storage engine constructed based on the key-value storage system, and improve graph query efficiency, thereby ensuring that the graph storage engine has relatively efficient graph query performance.

### BRIEF DESCRIPTION OF DRAWINGS

The following describes the accompanying drawings required for description of the example implementations.

FIG. 1 is a schematic diagram illustrating a key-value storage system according to an example implementation of the present application;

FIG. 2 is a schematic diagram illustrating a graph storage file according to an example implementation of the present application;

FIG. 3 is a flowchart illustrating a graph query method according to an example implementation of the present application;

FIG. 4 is a schematic structural diagram illustrating a device according to an example implementation of the present application; and

FIG. 5 is a block diagram illustrating a graph query apparatus according to an example implementation of the present application.

### DESCRIPTION OF EMBODIMENTS

Example implementations are described in detail herein, and examples of the example implementations are presented in the accompanying drawings. When the following description relates to the accompanying drawings, unless specified otherwise, same numbers in different accompanying drawings represent same or similar elements. The implementations described in the following example implementations do not represent all implementations consistent with one or more implementations of the present application. On the contrary, the implementations are merely examples consistent with some aspects of one or more implementations of the present application.

It should be noted that, in other implementations, the steps of the corresponding method are not necessarily performed in the sequence shown and described in the present application. In some other implementations, the method can include more or fewer steps than those described in the present application. In addition, a single step described in the present application may be broken down into a plurality of steps in other implementations for description, and a plurality of steps described in the present application may be combined into a single step in other implementations for description.

A storage system is usually a combination of hardware and software used in an entire computer system to store data. The storage system not only includes physical storage media such as a hard disk drive (HDD), a solid-state drive (SSD), a tape library, etc., but also includes data processing capacity such as file systems that manage these media, storage services at an operating system level, etc. In a database environment, the storage system is responsible for providing a persistent storage space, and ensuring that data can be safely and reliably stored on physical media and accessed efficiently.

A storage engine is a component, in a database management system (DBMS), that is responsible for managing how to store, retrieve, and update data. The storage engine determines a physical storage structure of data on a disk and supported functions such as transaction processing and concurrent control.

The storage engine works with an underlying storage system to implement actual data read/write operations. The storage engine cannot complete persistent storage of data without a physical storage capability provided by the storage system. In addition, the storage engine improves performance by understanding and/or controlling characteristics of the storage system. For example, some storage engines may adjust index structures or caching policies of the storage engines based on obtained features of the storage medium, which improves data access efficiency.

The storage system can be considered as an underlying storage infrastructure of the storage engine. The storage system is responsible for providing a reliable storage capability, and ensuring security and availability of data. The storage engine implements more advanced data management and access functions on this basis.

Graph storage is a data storage solution designed for a graph data structure, and aims to efficiently store and manage a large amount of graph data such as mutually connected nodes, edges, and attributes.

A graph storage system can be improved in terms of operations on the nodes, the edges, and the attributes thereof, which support fast queries, traversal, and other graph-related computing tasks. In the graph storage system, the graph data is usually stored in a file form, for example, persistently stored on the disk in the file form. Files constitute basic storage units of the graph data in the graph storage system.

A graph storage engine constructed in the graph storage system, e.g., a graph storage engine with the graph storage system as underlying storage, is responsible for data access logic corresponding to the graph storage system, including a storage structure (for example, a file format), an indexing manner, transaction processing, concurrent control, etc.

In practice, the graph storage system can usually include two types: a native graph storage system and a non-native graph storage system.

The native graph storage system is a storage system designed for a graph, and directly organizes data in forms of nodes, edges, and attributes. Example features of such a storage model include: The nodes and the edges are directly represented as independent objects at a physical storage level, and have respective identifiers (IDs), attribute sets, and references to other related objects, instead of being indirectly represented through relational tables or key-value pairs. The node usually includes a list of references pointing to all adjacent nodes (e.g., target nodes to which edges connected to the node point) of the node. The edge can also be directly linked to two nodes connected to the edge, which supports a fast graph traversal operation. For example, all nodes and edges in the graph are accessed and processed based on a policy. For example, a jump is made from one node to another node along an edge. Consistency and persistence of the graph data are improved.

The native graph storage system is configured based on characteristics of a graph topology and a graph query. The graph topology is a connection mode and a structural characteristic between a node and an edge in a graph, and the graph query is a process of querying graph data in the storage system. For example, based on features of the graph data structure and common graph query modes, adjustment and improvement are performed in terms of the file format, the indexing manner, etc. corresponding to the storage system, so that a file used to store the graph data in the native graph storage system is graph-aware. In this case, for the graph storage engine constructed in the native graph storage system, complexity of graph query operations of the graph storage engine in the native graph storage system can be reduced, and graph query efficiency is improved, thereby ensuring that the graph storage engine has relatively efficient graph query performance.

The non-native graph storage system usually converts a graph into a data structure in another form for storage, for example, a table in a relational database or a key-value pair in a key-value storage system.

The non-native graph storage system usually does not have a capability of directly mapping a node or an edge, and does not specially configure graph traversal operations. For example, the file used to store the graph data in the non-native graph storage system is usually graph-unaware, resulting in poor query performance of the graph storage engine constructed based on the non-native graph storage system. For example, complexity of graph query operations of the graph storage engine in the non-native graph storage system is relatively high, and graph query efficiency is relatively low.

The key-value storage system is a simple and efficient database model, and stores data by using a key-value pair. In the key-value storage system, each record has a unique key and a value associated with the key. The key is a unique identifier, and is used to locate a value stored in the database. Usually, the key is in a string form, or can be another type of data. The value is an actual data item associated with the key. The value can be data in any form, for example, a string, a number, or a binary object. In some cases, the value can be of a complex data structure, for example, a JSON document or a serialized object.

A design of the key-value storage system is very simple, and usually provides only basic operations such as insertion (Put), get/exact search (Get), range search or traversal (Seek), and deletion (Delete), without complex model definitions or relationship constraints. Therefore, it is easy to implement, deploy, and maintain the key-value storage system. Due to a simple data structure, the key-value storage system usually has a very high read/write performance, and can provide an extremely high read/write throughput and a low-latency response time.

The key-value storage system has excellent scalability and flexibility. For example, most key-value storage systems are designed as distributed systems, and support horizontal scaling to adapt to requirements for a larger data amount and a higher throughput. In addition, a format and content of the value in the key-value pair are usually unconstrained. Therefore, how to organize data and form a storage data structure can be freely selected according to an actual requirement. The key-value storage system can further provide different consistency guarantees, ranging from strong consistency to eventual consistency, etc., depending on an application scenario and a technical implementation.

Due to good scalability and flexibility of the key-value storage system, in practice, the graph data can be converted into a data structure of the key-value pair and stored in the key-value storage system, to convert the key-value storage system into a graph storage system. Constructing the graph storage engine based on the key-value storage system can take advantage of an existing complete key-value storage system ecosystem and infrastructure.

However, the graph storage system constructed based on the key-value storage system is a non-native graph storage system. This means that the file used to store the graph data in such a storage system is actually graph-unaware. Therefore, graph query performance of the graph storage engine constructed based on the key-value storage system is greatly affected.

In the present application, the key-value storage system is configured based on the characteristics of the graph topology and the graph query. A graph-aware SSTable file format obtained through adjustment and improvement based on an original SSTable file format in the key-value storage system is proposed. Correspondingly, adjustment and improvement are performed in terms of the indexing manner. As such, the graph storage engine constructed based on the configured key-value storage system has relatively efficient query performance.

For example, one or more implementations of the present application provide technical solutions for implementing a graph query. In the technical solutions, a node and an edge in a graph can be stored in an SSTable file; the SSTable file can include at least one first data block used to store a key-value pair corresponding to the node and the edge, and a second data block used to store an edge attribute of the edge; the node and the edge can be respectively represented by a first key-value pair and a second key-value pair, and be stored in the first data block; in a first key-value pair corresponding to a node, a key can include a node identifier of the node, and a value can include a node attribute of the node; in a second key-value pair corresponding to an edge, a key can include a start identifier and a destination identifier of the edge, and a value can include storage location information of the edge attribute of the edge in the SSTable file; and each target first key-value pair, and a target second key-value pair whose start identifier is the same as a node identifier in the target first key-value pair can be aggregated and stored in the first data block. Correspondingly, when a target key used to query the graph is obtained, the SSTable file can be queried based on a target node identifier in the target key, to determine a target first data block used to aggregate and store a first key-value pair and a second key-value pair that include the target node identifier; then the target first data block is queried based on the target key, to determine a target value corresponding to the target key; and a graph query result is determined based on the target value. For example, the node attribute can be determined as a graph query result in response to the target value being the node attribute; or in response to the target value being the storage location information, based on the storage location information, an edge attribute corresponding to the target key can be determined in the second data block included in the SSTable file, and the edge attribute corresponding to the target key can be determined as a graph query result.

According to some implementations, a key-value storage system is configured by using characteristics of a graph topology and a graph query. For example, the key-value storage system is adjusted and improved in terms of a format of the SSTable file, an indexing manner, etc., so that the SSTable file used to store graph data in the key-value storage system is graph-aware. This can reduce complexity of a graph query operation, in the key-value storage system, of a graph storage engine constructed based on the key-value storage system, and improve graph query efficiency, thereby ensuring that the graph storage engine has relatively efficient graph query performance.

In the present application, a graph database system can be a system used to store, manage, and query a graph data structure.

A storage space of the graph database system can have a sorted string table (SSTable) file stored therein. The SSTable file is used to store a node and an edge in a graph. The SSTable file can include at least one data block (which can be referred to as a first data block) used to store a key-value pair corresponding to the node and the edge, and a data block (which can be referred to as a second data block) used to store an edge attribute of the edge.

The node in the graph can be represented by a first key-value pair corresponding to the node, and the edge in the graph can be represented by a second key-value pair corresponding to the edge. The first key-value pair and the second key-value pair can be stored in the first data block. In the first key-value pair, a key can include a node identifier of the node, and a value can include a node attribute of the node; and in the second key-value pair, a key can include a start identifier and a destination identifier of the edge, and a value can be related to an edge attribute of the edge. For example, a value can include storage location information of the edge attribute of the edge in the SSTable file.

Each first key-value pair can be sequentially used as a target first key-value pair, and a second key-value pair with the same start identifier as a node identifier in the target first key-value pair can be used as a target second key-value pair. The target first key-value pair and the target second key-value pair can be aggregated and stored in the first data block.

It should be noted that the graph database system can include, for example, a key-value storage system used to store graph data by using a data structure of a key-value pair. For example, the key-value storage system provides the storage space of the graph database system. The graph database system can further include a storage engine that is used to convert the graph data into the data structure of the key-value pair, to satisfy a storage requirement. The storage engine can be a graph storage engine constructed based on the key-value storage system, e.g., a graph storage engine with the key-value storage system as underlying storage.

The following provides detailed descriptions by using the key-value storage system and the graph storage engine constructed based on the key-value storage system as examples.

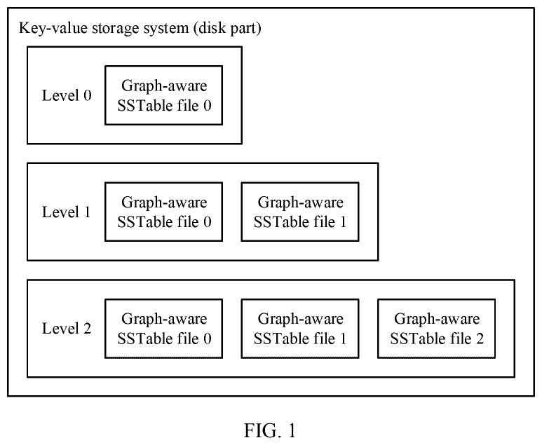

FIG. 1 is a schematic diagram illustrating a key-value storage system according to an example implementation of the present application.

As shown in FIG. 1, a graph storage engine can organize data by using a data structure, e.g., a log structured merge tree (LSM-Tree) in the key-value storage system.

The LSM-Tree is a data structure configured for processing a large number of write operations. A design of the LSM-Tree is tended to append new data to an end of a file, instead of perform updating in place. The LSM-Tree appends all new write operations to one or more ordered data structures in a memory, and then writes those data into persistent storage on a disk in batches and sequentially at a proper time. The data structure can reduce random write operations on the disk, thereby reducing random write overheads, and can maintain query efficiency in a background merge process.

The LSM-Tree manages data by using a multi-layer structure. Levels start from Mem Table in the memory and then there is a gradual migration to a plurality of levels on a hard disk. Each level includes one or more SSTable files. As a number of levels increases, a data amount of each level gradually increases, and a size of each level is usually several times that of a previous level.

For example, when data is written for the first time, the data is first stored in a memory data structure referred to as Mem Table. Mem Table is located in the memory, and is a sorted key-value pair set. All newly inserted data is first accumulated herein. Because Mem Table is an operation based on the memory, a write speed is very fast and a search operation can be performed quickly.

When current MemTable reaches a threshold size, the current MemTable is frozen and converted into an immutable state, e.g., Immutable MemTable, and waits to be written to the disk to become an immutable file, e.g., an SSTable file. Such a manner reduces frequent disk write operations, thereby improving write performance.

The SSTable file is written into the disk to form a first level (L0). The SSTable is a read-only file format, and includes sequentially arranged key-value pairs. To accelerate a search speed, each SSTable can have associated metadata information (for example, a Bloom filter and an index), which can be used to quickly locate a block that may include a target key.

As time goes by, more SSTable files are accumulated at the L0 level. In some implementations, to maintain efficient running and good query performance of the system, the system periodically performs a merge (compaction) operation, merging data at the L0 level into a next level (L1), and removing a repeated or expired data item. A merge process continues, until the data reaches the lowest level. In some implementation, the merge operation is asynchronous and does not block a write path.

It should be noted that the L0 level is a level closest to the memory, and usually includes an SSTable file that has just been refreshed from the MemTable in the memory to the disk. The SSTable files at the L0 level may not be sorted by key, because the SSTable files are independently generated from different memtables. When a number of SSTable files at the L0 level exceeds a threshold, minor compaction is triggered, which merges and sorts the files, and then migrates a result to the L1 level.

Starting from the L1 level, SSTable files at each level are sorted by key. A number and sizes of SSTable files at each level usually increase level by level. For example, the SSTable files at the L1 level may be larger than those at the L0 level, and SSTable files at an L2 level may be larger than those at the L1 level. When a number or a total size of SSTable files at a level exceeds a predetermined threshold, major compaction is triggered. Some files at the level are merged with files at a next level, to generate a larger SSTable file, and migrate a result to the next level.

When the graph storage engine queries the key-value storage system in which LSM-Tree is used, the query starts from the MemTable in the memory and then SSTable files at each level are checked in sequence. Because the SSTable files at each level are sorted by key, data can be quickly located based on an efficient algorithm such as a binary search.

For example, when the query is performed, the Mem Table in the memory is first searched.

If required data cannot be identified in the Mem Table, the SSTable files at each level that have been on the disk are searched in sequence (for example, if there is immutable MemTables, immutable Mem Tables is first identified, and then the SSTable files are searched). In a query process, impact of merging is also considered. For example, all related SSTable files are traversed, to ensure acquisition of the latest data version.

Before an SSTable file is accessed, whether the SSTable file may include a target key can be determined by using a Bloom filter associated with the SSTable file. If the Bloom filter indicates that the target key does not exist in the SSTable file, the SSTable file may not be accessed, thereby avoiding unnecessary disk I/O operations.

Finally, in the query process, results from the Mem Table, the immutable Mem Tables, and each SSTable are merged, and the latest and unique key-value pair is returned.

For example, it is assumed that, in the key-value storage system in which the LSM-Tree is used, there is one MemTable, one SSTable file at the L0 level, and two SSTable files (a sequence is SSTable file 1 and SSTable file 2) at the L1 level, and key space is from key_0 to key_9. When a key key_5 is queried, the Mem Table is first searched. If key_5 is not identified, the SSTable file at the L0 level continues to be searched. If key_5 is identified in the SSTable file at the L0 level, a value corresponding to key_5 is value_old, and the SSTable file 1 at the L1 level continues to be searched. If key_5 is not identified, the SSTable file 2 at the L1 level continues to be searched. If key_5 is also identified in the SSTable file 2 at the L1 level, a value corresponding to key_5 is value_new, and it is determined, based on a timestamp or another mechanism, that the value is an updated value. In this case, the latest value value_new corresponding to key_5 is finally returned.

It can be learned, from the descriptions herein, that an original SSTable file stores key-value pairs arranged based on a sequence of keys. Therefore, when the original SSTable file is used to store graph data, the graph data is converted into data in a form of a key-value pair for storage. For example, the original SSTable file is graph-unaware.

In the key-value storage system in FIG. 1, the graph-unaware original SSTable file can be replaced by a graph-aware, adjusted, and improved SSTable file (which can be referred to as a graph-aware SSTable file).

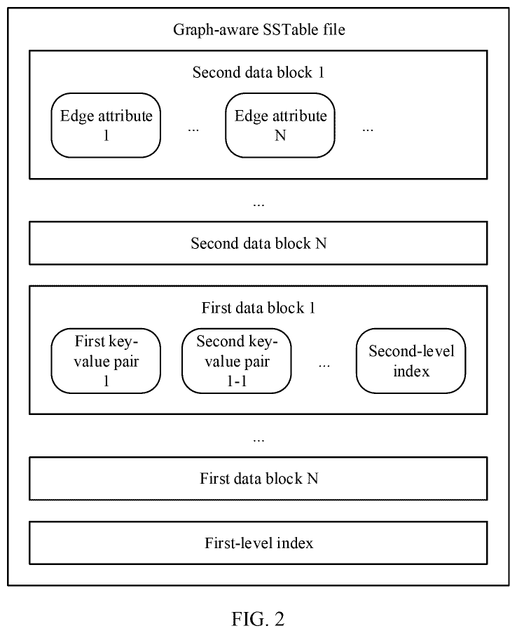

FIG. 2 is a schematic diagram illustrating a graph storage file according to an example implementation of the present application.

As shown in FIG. 2, the graph storage file (namely, a file used to store graph data) can be a graph-aware SSTable file that is graph-aware and that is obtained through adjustment and improvement based on an original SSTable file.

The original SSTable file usually includes a data block and an index block. The data block is the most fundamental data storage unit in the SSTable file, and is used to store data that is actually in a form of a key-value pair, and the stored key-value pair is arranged based on a sequence of keys. The index block is used to store meta-information of each data block, for example, a key range of the data block (a range of the minimum key and the maximum key) and an offset (which can indicate a start location) of the data block in the SSTable file. The index block can accelerate a search process, so that a data block in which a target key is located can be quickly located.

In addition to the data block and index block, a complete SSTable file may further include another auxiliary component, for example, a footer, Bloom filter, and metadata. The footer is located at an end of the file and includes an offset of the index block and other metadata information (for example, the Bloom filter) in the SSTable file, to quickly identify the index block. The Bloom filter is a probabilistic data structure, and is used to quickly determine whether a key exists in the SSTable file, thereby reducing unnecessary disk I/O operations. Metadata includes other auxiliary information, for example, a size of the file, a creation moment, or a version number.

For the graph-aware SSTable file in FIG. 2, it should be first noted that the graph-aware SSTable file stores key-value pairs (which can be respectively referred to as a first key-value pair and a second key-value pair) by a node and an edge in a graph are represented. For example, the node in the graph can be represented by the first key-value pair corresponding to the node, and the edge in the graph can be represented by the second key-value pair corresponding to the edge.

In some implementations, all key-value pairs stored in the first data block can be arranged based on a sequence (usually a lexicographical order) of keys, which, among others, helps search the above first data block for a key-value pair. When there are a plurality of first data blocks, key-value pairs stored in two adjacent first data blocks are also arranged based on a sequence of keys.

A node is used as an example. In a first key-value pair by which the node is represented, a key can include a node identifier of the node, and a value can include a node attribute of the node (which can be, for example, encoded node attribute data). An edge is used as an example. In a second key-value pair into which the edge is organized, a key can include a node identifier (briefly referred to as a start identifier) of a source node (source node/start node) and a node identifier (briefly referred to as a destination identifier) of a destination node (target node/destination node) of the edge, and a value includes an edge attribute (which can be, for example, encoded edge attribute data) of the edge.

In some implementations, an edge attribute can be stored separately in a key-value storage system, which can accelerate a filtering query of the edge and improve efficiency of a graph query and graph traversal. In this case, the graph-aware SSTable file can be used to store a data block (which can be referred to as a second data block) of the edge attribute of the edge in the graph. The data block is similar to the data block in the original SSTable file. There can be exactly one second data block, and the second data block stores edge attributes of all edges. Alternatively or additionally, the data block can be similar to the first data block, and a data amount of an edge attribute stored in each second data block is not greater than a predetermined threshold.

For example, one edge is used as an example. An edge attribute (which can be encoded edge attribute data) of the edge can be stored in the above second data block. In a second key-value pair by which the edge is represented, a key can include a node identifier (briefly referred to as a start identifier) of a source node (source node or start node) and a node identifier (briefly referred to as a destination identifier) of a destination node (target node or destination node) of the edge, and a value includes storage location information of the edge attribute of the edge in the graph-aware SSTable file.

When the second data block stores a key-value pair including the key in the second key-value pair and the edge attribute, it indicates that the second data block is queried by using the key. Therefore, the storage location information of the edge attribute in the graph-aware SSTable file can be, for example, storage location information of the second data block in which the edge attribute is located in the graph-aware SSTable file.

When the second data block stores only the edge attribute, to save storage resources, the storage location information of the edge attribute in the graph-aware SSTable file is storage location information of the edge attribute in the graph-aware SSTable file, e.g., storage location information of the edge attribute in the second data block.

In some implementations, all edge attributes stored in the second data block can be arranged based on a sequence of keys in a corresponding second key-value pair, which, among others, helps search the second data block for an edge attribute.

In some implementations, graphs can include a directed graph (Directed Graph/Digraph) and an undirected graph. In the directed graph, each edge has a direction, pointing from one node to another node. Therefore, each edge in the directed graph can be represented by one second key-value pair. In the undirected graph, an edge has no direction, which means that two nodes connected by each edge are bidirectionally reachable. Therefore, for the undirected graph, it can be considered that each undirected edge includes two directed edges. For example, if an edge connects a node A and a node B in the undirected graph, the edge can be considered as an edge pointing from the node A to the node B and an edge pointing from the node B to the node A. Therefore, the edge can be represented by two second key-value pairs. A start identifier included in a key in one second key-value pair is a node identifier of the node A, and a destination identifier is a node identifier of the node B. A start identifier included in a key in another second key-value pair is a node identifier of the node B, and a destination identifier is a node identifier of the node A.

The first key-value pair can be shown in Table 1:

TABLE 1

| | | |
|---|---|---|
| Node | Key | Value |
| | Node identifier | Node attribute |

In some implementations, a key in a first key-value pair by which one node is represented can include a node type of the node in addition to a node identifier of the node. A content of the key and the value in the first key-value pair can be set according to an actual requirement. This is not specially limited in the present application.

The second key-value pair can be shown in Table 2:

TABLE 2

| Node | Key | | Value |
|---|---|---|---|
| | Start | Destination | Edge attribute or storage location |
| | identifier | identifier | information of an edge attribute |

In some implementations, a key in a second key-value pair by which an edge is represented can include a node type (briefly referred to as a start type) of a source node of the edge and/or an establishment timestamp of the edge in addition to a start identifier and a destination identifier of the edge. A content of the key and the value in the second key-value pair can be set according to an actual requirement. This is not specially limited in the present application.

The graph-aware SSTable file can include at least one data block (which can be referred to as a first data block) used to store the first key-value pair and the second key-value pair. The data block is similar to the data block in the original SSTable file.

It should be noted that each (which can be referred to as a target first key-value pair) of all first key-value pairs and a second key-value pair (which can be referred to as a target second key-value pair) whose start identifier is same as a node identifier in the target first key-value pair can be aggregated and stored in the first data block. For example, if a node identifier included in a key in the target first key-value pair is a node identifier A, a start identifier included in a key in the target second key-value pair is also the node identifier A, and the target first key-value pair and the target second key-value pair can be aggregated and stored in the first data block.

The node identifier in the target first key-value pair is the same as the start identifier in the target second key-value pair, which means that a start of the edge corresponding to the target second key-value pair is the node corresponding to the target first key-value pair. Therefore, the target first key-value pair and the target second key-value pair are aggregated and stored, to jointly access a node and an edge connected to the node, thereby accelerating a query of the node and a point connected to the node, and improving efficiency of the graph query and graph traversal.

Correspondingly, in the graph-aware SSTable file, the first key-value pair and the second key-value pair can be, for example, arranged based on a sequence of the minimum key in the first key-value pair and the second key-value pair that are aggregated and stored in each group. For example, the target first key-value pair and the target second key-value pair are a first key-value pair and a second key-value pair that are aggregated and stored in each group. Because data content included in a key in the first key-value pair is less than data content included in a key in the second key-value pair, based on the lexicographical order, the minimum key in the target first key-value pair and the target second key-value pair that are aggregated and stored in each group is usually a key in the target first key-value pair.

The target first key-value pair and the target second key-value pair are aggregated and stored in the first data block. For example, the target first key-value pair and the target second key-value pair can be aggregated and stored in the same first data block.

For example, it is assumed that a node identifier included in a key in a first key-value pair 1 is a node identifier A, a node identifier included in a key in a first key-value pair 2 is a node identifier B, start identifiers included in a key in a second key-value pair 1-1 and a key in a second key-value pair 1-2 are both the node identifier A, and start identifiers included in a key in a second key-value pair 2-1, a key in a second key-value pair 2-2, a key in a second key-value pair 2-3, a key in a second key-value pair 2-4, a key in a second key-value pair 2-5, and a key in a second key-value pair 2-6 are all the node identifier B. It is assumed that a lexicographical order of keys is as follows: the key in the first key-value pair 1<the key in the second key-value pair 1-1<the key in the second key-value pair 1-2, the key in the first key-value pair 2<the key in the second key-value pair 2-1<the key in the second key-value pair 2-2<the key in the second key-value pair 2-3<the key in the second key-value pair 2-4<the key in the second key-value pair 2-5<the key in the second key-value pair is 2-6, and the key in the first key-value pair 1<the key in the first key-value pair 2. In this case, one first data block can store (the first key-value pair 1, the second key-value pair 1-1, and the second key-value pair 1-2), and another first data block can store (the first key-value pair 2, the second key-value pair 2-1, the second key-value pair 2-2, the second key-value pair 2-3, the second key-value pair 2-4, the second key-value pair 2-5, and the second key-value pair 2-6).

Similar to the data block in the original SSTable file, each first data block may have a limited size, to improve query efficiency of the first data block. When this limit is reached, a new key-value pair is written into a next first data block. For example, a data amount of a first key-value pair and a second key-value pair stored in each first data block is not greater than the predetermined threshold. The data amount can be a number of key-value pairs or can be a data size of the key-value pair. This is not specially limited in the present application. Correspondingly, the target first key-value pair and the target second key-value pair are aggregated and stored in the first data block. For example, the target first key-value pair and the target second key-value pair can be aggregated and stored in one or more consecutive first data blocks.

A first key-value pair and a second key-value pair that include different node identifiers can be stored in different first data blocks. For example, it is assumed that a node identifier included in a key in a first key-value pair 1 is a node identifier A, a node identifier included in a key in a first key-value pair 2 is a node identifier B, start identifiers included in a key in a second key-value pair 1-1 and a key in a second key-value pair 1-2 are both the node identifier A, and start identifiers included in a key in a second key-value pair 2-1, a key in a second key-value pair 2-2, a key in a second key-value pair 2-3, a key in a second key-value pair 2-4, a key in a second key-value pair 2-5, and a key in a second key-value pair 2-6 are all the node identifier B. It is assumed that a number of key-value pairs stored in one first data blocks is not greater than 5. It is assumed that a lexicographical order of keys is as follows: the key in the first key-value pair 1<the key in the second key-value pair 1-1<the key in the second key-value pair 1-2, the key in the first key-value pair 2<the key in the second key-value pair 2-1<the key in the second key-value pair 2-2<the key in the second key-value pair 2-3<the key in the second key-value pair 2-4<the key in the second key-value pair 2-5<the key in the second key-value pair is 2-6, and the key in the first key-value pair 1<the key in the first key-value pair 2. In this case, one first data block can store (the first key-value pair 1, the second key-value pair 1-1, and the second key-value pair 1-2), another first data block can store (the first key-value pair 2, the second key-value pair 2-1, the second key-value pair 2-2, the second key-value pair 2-3, and the second key-value pair 2-4), and still another first data block can store (the second key-value pair 2-5 and the second key-value pair 2-6).

A first key-value pair and a second key-value pair that include different node identifiers can alternatively or additionally be stored in the same first data block. The above example is still used. One first data block can store (the first key-value pair 1, the second key-value pair 1-1, the second key-value pair 1-2, the first key-value pair 2, and the second key-value pair 2-1), and another first data block can store (the second key-value pair 2-2, the second key-value pair 2-3, the second key-value pair 2-4, the second key-value pair 2-5, and the second key-value pair 2-6).

In addition, the graph-aware SSTable file can further include an index (which can be referred to as a first-level index) created based on the node identifier in the first key-value pair, to help determine the first key-value pair and the second key-value pair that include a node identifier and that are aggregated and stored.

It should be noted that the first-level index can be used to indicate a first data block in which a first key-value pair and a second key-value pair that include the node identifier are located. The first key-value pair and the second key-value pair that include the same node identifier are the first key-value pair and the second key-value pair that are aggregated and stored.

For example, the first-level index can include each node identifier, and a correspondence with storage location information, in the graph-aware SSTable file, of a first data block in which the first key-value pair and the second key-value pair that include the node identifier are located. The storage location information of the first data block in the graph-aware SSTable file can include an offset (which can indicate a start location) of the first data block in the graph-aware SSTable file. In addition, the storage location information can further include other auxiliary information, for example, a size of the first data block, to help determine an end location of the first data block.

For example, it is assumed that the first data block 1 stores (the first key-value pair 1, the second key-value pair 1-1, the second key-value pair 1-2, the first key-value pair 2, and the second key-value pair 2-1), and the first data block 2 stores (the second key-value pair 2-2, the second key-value pair 2-3, the second key-value pair 2-4, the second key-value pair 2-5, and the second key-value pair 2-6). In this case, a first data block in which the first key-value pair 1, the second key-value pair 1-1, and the second key-value pair 1-2 that include the node identifier A are located is the first data block 1; a first data block in which the first key-value pair 2, the second key-value pair 2-1, the second key-value pair 2-2, the second key-value pair 2-3, the second key-value pair 2-4, the second key-value pair 2-5, and the second key-value pair 2-6 that include the node identifier B are located includes a first data block 1 and a first data block 2. A first-level index created based on the node identifier in the first key-value pair 1 and the node identifier in the first key-value pair 2 can be shown in Table 3:

TABLE 3

| | | |
|---|---|---|
| First- | Node identifier | Storage location information |
| level | Node identifier A | Storage location information of a first data |
| index | | block 1 |
| | Node identifier B | Storage location information of a first data |
| | | block 1 and storage location information of a |
| | | first data block 2 |

The storage location information of the first data block 1 in Table 3 is storage location information of the first data block 1 in the graph-aware SSTable file, and the storage location information of the first data block 2 is storage location information of the first data block 2 in the graph-aware SSTable file.

Further, the first-level index can include each node identifier, and a correspondence with storage location information, in the graph-aware SSTable file, of the first first data block in which the first key-value pair and the second key-value pair that include the node identifier are located. Correspondingly, the correspondence between a node identifier and storage location information in the first-level index can be arranged based on a sequence of the first key-value pair including each node identifier in the first data block. For example, when key-value pairs stored in the first data block are arranged based on a sequence of keys, the correspondence between a node identifier and storage location information in the first-level index can be arranged based on a sequence of the minimum key in the first key-value pair and the second key-value pair that include each node identifier.

For example, it is assumed that the node identifier included in the key in the first key-value pair 1 is the node identifier A, the node identifier included in the key in the first key-value pair 2 is the node identifier B, and the node identifier included in the key in the first key-value pair 3 is the node identifier C. It is assumed that the key in the first key-value pair 1<the key in the first key-value pair 2<the key in the first key-value pair 3. It is assumed that the first key-value pair and the second key-value pair that include the node identifier A are aggregated and stored in the first data block 1, the first key-value pair and the second key-value pair that include the node identifier B are aggregated and stored in the first data block 1 and the first data block 2, and the first key-value pair and the second key-value pair that include the node identifier C are aggregated and stored in the first data block 3. In this case, in the first-level index, an arrangement sequence of the correspondence between a node identifier and storage location information can be: a correspondence between the node identifier A and storage location information of the first data block 1, a correspondence between the node identifier B and the storage location information of the first data block 1, and a correspondence between the node identifier C and storage location information of the first data block 3. Because the first first data block in which the first key-value pair and the second key-value pair that include the node identifier A are located is the first data block 1, the first first data block in which the first key-value pair and the second key-value pair that include the node identifier B are located is also the first data block 1, and the first first data block in which the first key-value pair and the second key-value pair that include the node identifier C are located is the first data block 3. The first-level index created based on the node identifier in the first key-value pair 1, the node identifier in the first key-value pair 2, and the node identifier in the first key-value pair 3 can be shown in Table 4:

TABLE 4

| | | |
|---|---|---|
| First- | Node identifier | Storage location information |
| level | Node identifier A | Storage location information of a first data |
| index | | block 1 |
| | Node identifier B | Storage location information of a first data |
| | | block 1 |
| | Node identifier C | Storage location information of a first data |
| | | block 3 |

In the above case, the first data block used to aggregate and store the first key-value pair and the second key-value pair that include the same node identifier in the graph-aware SSTable file can be determined based on the arrangement sequence of the correspondence between a node identifier and storage location information in the first-level index. For example, for a node identifier, based on the correspondence including the node identifier and a next correspondence of the correspondence, in the graph-aware SSTable file, a first data block within a range from a first data block indicated by storage location information included in the correspondence to a first data block indicated by storage location information included in the next correspondence of the correspondence is determined as the first data block used to aggregate and store the first key-value pair and the second key-value pair that include the node identifier in the Graph-Aware SSTable file. The above example is still used. Because a next correspondence of a correspondence between the node identifier B and the storage location information of the first data block 1 is a correspondence between the node identifier C and the storage location information of the first data block 3, a first data block within a range from the first data block 1 to the first data block 3 can be determined as a first data block used to aggregate and store the first key-value pair and the second key-value pair that include the node identifier B. In other words, the first data block 1 and the first data block 2 necessarily store the first key-value pair and the second key-value pair that include the node identifier B, and the first data block 3 may store the first key-value pair and the second key-value pair that include the node identifier C.

The first-level index can be a hash index, to reduce search time complexity of the first-level index, thereby accelerating a query of a node and a point connected to the node, and improving efficiency of a graph query and graph traversal. For example, the first-level index can include, for example, a hash value of each node identifier, and a correspondence with storage location information, in the graph-aware SSTable file, of the first data block in which the first key-value pair and the second key-value pair that include the node identifier are located.

Alternatively or additionally, the first-level index can be an index block in the original SSTable file. In this case, the first-level index can include, for example, a range of a node identifier in a first key-value pair included in each first data block, and a correspondence with storage location information of the first data block in the graph-aware SSTable file.

It should be noted that, for a graph including a node and an edge corresponding to a key-value pair stored in the graph-aware SSTable file, if the graph is a sparse graph (e.g., a number of edges is relatively small), it indicates that a first data block in the graph-aware SSTable file may include a plurality of first key-value pairs. Therefore, the first-level index in the graph-aware SSTable file can be an index block in the SSTable file. If the graph is a dense graph (e.g., a number of edges is relatively large, for example, the number of edges is close to a square of a number of nodes), it indicates that the first key-value pairs in the graph-aware SSTable file may be scattered in discontinuous first data blocks. Therefore, the first-level index in the graph-aware SSTable file can be a hash index.

In some implementations, Cuckoo hashing can be used to create the first-level index based on the node identifier in the first key-value pair.

When the target first key-value pair and the target second key-value pair are aggregated and stored in a plurality of consecutive first data blocks, the first first data block in the plurality of first data blocks can further store an index (which can be referred to as a second-level index) created based on a key in the target second key-value pair, to help determine the first data block used to aggregate and store the first key-value pair and the second key-value pair that include the same node identifier, thereby accelerating a query of a node and a point connected to the node, and improving efficiency of a graph query and graph traversal.

It should be noted that the second-level index can be used to indicate a first data block in which the target second key-value pair is located. In this case, the first-level index can be used to indicate, for example, the first first data block in which the first key-value pair and the second key-value pair that include each node identifier are located. For example, in this case, the first-level index is only used to identify the first first data block in which a first key-value pair and a second key-value pair that include a node identifier in the target key are located. The remaining first data blocks can be identified through a second-level index in the first first data block.

For example, the second-level index can include a key range of a target second key-value pair in each first data block included in the plurality of consecutive first data blocks, and a correspondence with storage location information of the first data block in the graph-aware SSTable file. The storage location information can include an offset (which can indicate a start location) of the first data block in the graph-aware SSTable file. In addition, the storage location information can further include other auxiliary information, for example, a size of the first data block, to help determine an end location of the first data block.

In some implementations, for the N^{th} (N is a natural number) first data block in the plurality of consecutive first data blocks, a key range of target second key-value pairs in the N^{th} first data block can be represented by the minimum key and the maximum key in the target second key-value pairs; or can be represented by the maximum key in the target second key-value pairs in the N^{th} first data block and the maximum key in target second key-value pairs in the (N+1)th first data block. For example, a key range of target second key-value pairs in a first data block in the second-level index can be, for example, a range of the minimum key and the maximum key in the target second key-value pairs in the first data block, or can only be the maximum key in the target second key-value pairs in the first data block.

For example, it is assumed that the first data block 1 stores (the first key-value pair 1, the second key-value pair 1-1, the second key-value pair 1-2, the first key-value pair 2, and the second key-value pair 2-1), and the first data block 2 stores (the second key-value pair 2-2, the second key-value pair 2-3, the second key-value pair 2-4, the second key-value pair 2-5, and the second key-value pair 2-6). In this case, it indicates that when the target first key-value pair is the first key-value pair 2, and the target second key-value pair includes the second key-value pair 2-1, the second key-value pair 2-2, the second key-value pair 2-3, the second key-value pair 2-4, the second key-value pair 2-5, and the second key-value pair 2-6, the target first key-value pair and the target second key-value pair are aggregated and stored in two consecutive first data blocks, namely, the first data block 1 and the first data block 2. In this case, because the maximum key in the target second key-value pair in the first data block 1 is a key in the second key-value pair 2-1, and the maximum key in the target second key-value pair in the first data block 2 is a key in the second key-value pair 2-6, the second-level index created based on the key in the target second key-value pair can be shown in Table 5:

TABLE 5

| Second- | Key range | Storage location information |
|---|---|---|
| level | Key in a second key-value pair | Storage location information |
| index | 2-1 | of a first data block 1 |
| | Key in a second key-value pair | Storage location information |
| | 2-6 | of a first data block 2 |

In addition, data stored in the first data block 1 can be, for example, (the first key-value pair 1, the second key-value pair 1-1, the second key-value pair 1-2, the first key-value pair 2, the second key-value pair 2-1, and the second-level index corresponding to the first key-value pair 2).

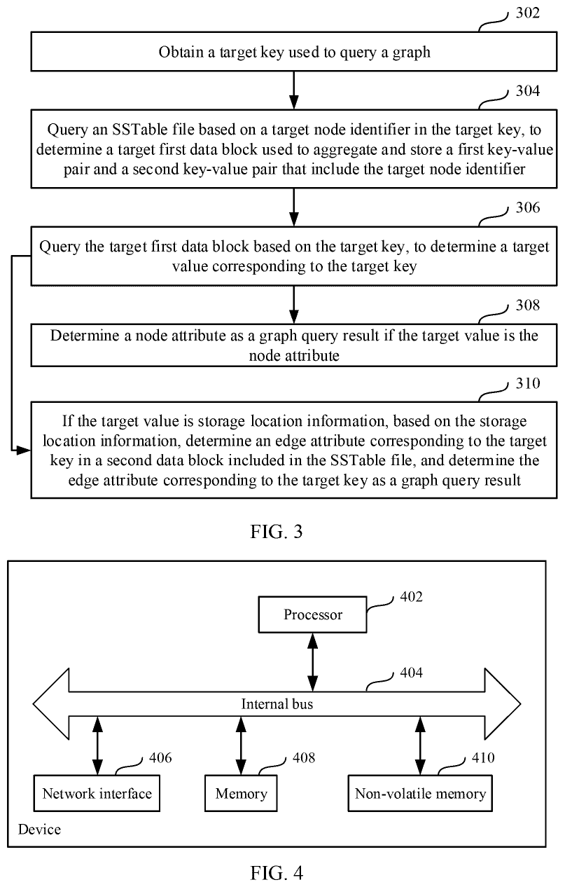

Based on FIG. 1 and FIG. 2, FIG. 3 is a flowchart illustrating a graph query method according to an example implementation of the present application.

In some implementations, as described above, a node and an edge in a graph can be stored in an SSTable file (which can be, for example, the graph-aware SSTable file shown in FIG. 2), and the SSTable file can include at least one first data block used to store a key-value pair corresponding to the node and the edge in the graph, and a second data block used to store an edge attribute of the edge in the graph.

The node in the graph can be represented by a first key-value pair corresponding to the node, and the edge in the graph can be represented by a second key-value pair corresponding to the edge. The first key-value pair and the second key-value pair are stored in the first data block. In a first key-value pair, a key can include a node identifier of a node, and a value can include a node attribute of the node; and in a second key-value pair, a key can include a start identifier and a destination identifier of an edge, and a value can include storage location information of an edge attribute of the edge in the SSTable file.

One of all first key-value pairs can serve as a target first key-value pair. The target first key-value pair and a second key-value pair (which can be referred to as a target second key-value pair) whose start identifier is same as a node identifier in the target first key-value pair can be aggregated and stored in the first data block.

It should be noted that the graph query method can be implemented by a graph storage engine constructed based on a key-value storage system, and is used to perform a graph query in the key-value storage system.

As shown in FIG. 3, the graph query method can include the following steps.

Step 302: Obtain a target key used to query the graph.

In some implementations, the graph can be queried based on a key (which can be referred to as the target key) through a Get operation and a Seek operation. For example, the Get (Key) operation or the Seek (Key) operation is performed. The key is the target key.

Step 304: Query the SSTable file based on a target node identifier in the target key, to determine a target first data block used to aggregate and store a first key-value pair and a second key-value pair that include the target node identifier.

In some implementations, as described herein, both a key in the first key-value pair and a key in the second key-value pair include a node identifier. Therefore, the node identifier (which can be referred to as the target node identifier) can be first extracted from the target key. Subsequently, the SSTable file can be queried based on the target node identifier, to determine a first data block (which can be referred to as the target first data block) used to aggregate and store a first key-value pair and a second key-value pair that include the target node identifier.

In some implementations, the SSTable file can further include a first-level index created based on the node identifier in the first key-value pair. The first-level index can be used to indicate a first data block in which a first key-value pair and a second key-value pair that include each node identifier are located, e.g., the first data block that aggregates and stores the first key-value pair and the second key-value pair that correspond to each other.

Because the first-level index is an index that is created based on the node identifier and that is used to indicate the first data block in which the first key-value pair and the second key-value pair that include each node identifier are located, the first data block used to aggregate and store the first key-value pair and the second key-value pair that include the target node identifier can be determined by querying the first-level index.

In some implementations, when the target key is obtained, a corresponding LSM-Tree can be queried based on the target key, to determine an SSTable file used to store a key-value pair including the target key in the LSM-Tree; and then the determined first-level index included in the SSTable file is queried based on the target node identifier in the target key.

As described above, whether the SSTable file may include the target key can be determined by using a Bloom filter associated with the SSTable file. For example, the SSTable file used to store the key-value pair including the target key can be determined through a Bloom filter associated with each SSTable file in the LSM-Tree included in the key-value storage system.

Step 306: Query the target first data block based on the target key, to determine a target value corresponding to the target key; and determine a graph query result based on the target value.

In some implementations, the target first data block can be queried based on the target key. Because the first data block is used to actually store the first key-value pair and the second key-value pair, the target value corresponding to the target key can be determined by querying the target first data block, and therefore, a graph query result can be determined based on the target value. For example, if the target value is the value in the first key-value pair, e.g., the node attribute, the node attribute can be determined as the graph query result; or if the target value is the value in the second key-value pair, that is, the edge attribute, the edge attribute can be determined as the graph query result.

Step 308: Determine the node attribute as a graph query result in response to the target value being the node attribute.

Step 310: In response to the target value being the storage location information, based on the storage location information, determine an edge attribute corresponding to the target key in the second data block included in the SSTable file, and determine the edge attribute corresponding to the target key as a graph query result.

In some implementations, as described herein, the SSTable file can further include the second data block used to store the edge attribute. A value in the second key-value pair can include storage location information of an edge attribute of a corresponding edge in the SSTable file.

When the graph query result is determined based on the target value, different operations can be performed based on a type of the target value. For example, in response to the target value being the value in the first key-value pair, e.g., the node attribute, the node attribute (e.g., the target value) can be directly determined as the graph query result; or in response to the target value being the value in the second key-value pair, e.g., the storage location information of the edge attribute in the SSTable file, the value corresponding to the target key, e.g., the edge attribute, can be determined in the second data block included in the SSTable file based on the storage address information in the target value, and the edge attribute corresponding to the target key is determined as the graph query result.

In some implementations, as described above, a data amount of the first key-value pair and the second key-value pair stored in the first data block is not greater than a threshold. Correspondingly, the target first key-value pair and the target second key-value pair may be aggregated and stored in one first data block, or may be aggregated and stored in a plurality of consecutive first data blocks.

In some implementations, when the target first key-value pair and the target second key-value pair are aggregated and stored in a plurality of consecutive first data blocks, the first first data block in the plurality of consecutive first data blocks can be further used to store a second-level index created based on a key in the target second key-value pair.

The second-level index can be used to indicate a first data block in which the target second key-value pair is located. Correspondingly, the first-level index can be used to indicate, for example, the first first data block in which the first key-value pair and the second key-value pair that include each node identifier are located.

When the graph query result is determined based on the target value, in response to the target value being the second-level index, the second-level index can be further queried first based on the target key. Because the second-level index is an index that is created based on the key in the target second key-value pair and that is used to indicate the first data block in which the target second key-value pair is located, the first data block corresponding to the target key can be determined by querying the second-level index. Subsequently, the first data block corresponding to the target key can be queried based on the target key, to determine the value corresponding to the target key, and the graph query result can be determined based on the value corresponding to the target key.

Similar to the above descriptions, when the graph query result is determined based on the value corresponding to the target key, because a second-level index hit by the target key in this case is created based on a key in a second key-value pair, and the value corresponding to the target key is related to the edge attribute, e.g., the storage location information of the edge attribute in the SSTable file. For example, the value corresponding to the target key, e.g., the edge attribute, can be determined, based on the storage address information in this value, in the second data block included in the SSTable file, and the edge attribute corresponding to the target key is determined as the graph query result.

It should be noted that the second-level index can exist independently in the first first data block, e.g., is not included in the first data block as a value in a key-value pair. In this case, when the target key does not match a key in each key-value pair included in the first data block, the second-level index in the first data block can be directly determined as the target value corresponding to the target key.

Alternatively or additionally, the second-level index can be included in the first first data block as a value in a key-value pair, and a key in this key-value pair can be a key range of the target second key-value pair. In this case, when the target key hits the key range in the first data block (the target key does not match a key in each key-value pair included in the first data block), the second-level index in the first data block can be determined as the target value corresponding to the target key.

In some implementations, as described above, the second-level index can include a key range of a target second key-value pair in each first data block included in the plurality of consecutive first data blocks, and a correspondence with storage location information of the first data block in the SSTable file.

Therefore, when the second-level index is further queried based on the target key, to determine the first data block corresponding to the target key, for example, a binary search can be further performed in the second-level index based on the target key, to determine storage location information of the first data block corresponding to the target key in the SSTable file, and the first data block corresponding to the target key is determined in the SSTable file based on the storage location information.

In some implementations, as described above, the first-level index can include each node identifier, and a correspondence with storage location information, in the SSTable file, of the first first data block in which the first key-value pair and the second key-value pair that include the node identifier are located. Correspondingly, the correspondence between a node identifier and storage location information in the first-level index can be arranged based on a sequence of the first key-value pair including each node identifier in the first data block.

In the above case, the target first data block used to aggregate and store the first key-value pair and the second key-value pair that include the target node identifier in the SSTable file can be determined based on an arrangement sequence of the correspondence between a node identifier and storage location information in the first-level index. For example, the first-level index included in the SSTable file can be first queried based on the target node identifier, to determine a correspondence (which can be referred to as a target correspondence) including the target node identifier, and a next correspondence of the target correspondence. Then, in the SSTable file, a first data block in a range from a first data block indicated by storage location information included in the target correspondence to a first data block indicated by storage location information included in the next correspondence of the target correspondence is determined as a target first data block.

In some implementations, for the key-value storage system, a format of the SSTable file included in the LSM-Tree can be selected based on an actual application scenario and a requirement.

The SSTable file is used as an example. When a subgraph including a node and an edge corresponding to a key-value pair stored in the SSTable file is a sparse subgraph, the first-level index in the SSTable file can be an index block in the SSTable file. When a subgraph including a node and an edge corresponding to a key-value pair stored in the SSTable file is a dense subgraph, the first-level index in the SSTable file can be a hash index.

For example, for a graph analysis scenario, it is more accessible to store edge attributes by column. Therefore, the edge attribute can be separately stored in the second data block.

It should be noted that formats of SSTable files included in the same LSM-Tree can be different. In this case, when SSTable files are merged, SSTable files with the same format can be merged.

In the above technical solutions, a node and an edge in a graph can be stored in an SSTable file; the SSTable file can include at least one first data block used to store a key-value pair corresponding to the node and the edge, and a second data block used to store an edge attribute of the edge; the node and the edge can be respectively represented by a first key-value pair and a second key-value pair, and be stored in the first data block; in a first key-value pair corresponding to a node, a key can include a node identifier of the node, and a value can include a node attribute of the node; in a second key-value pair corresponding to an edge, a key can include a start identifier and a destination identifier of the edge, and a value can include storage location information of the edge attribute of the edge in the SSTable file; and each target first key-value pair, and a target second key-value pair whose start identifier is the same as a node identifier in the target first key-value pair can be aggregated and stored in the first data block. Correspondingly, when a target key used to query the graph is obtained, the SSTable file can be queried based on a target node identifier in the target key, to determine a target first data block used to aggregate and store a first key-value pair and a second key-value pair that include the target node identifier; then the target first data block is queried based on the target key, to determine a target value corresponding to the target key; and a graph query result is determined based on the target value. For example, the node attribute can be determined as a graph query result in response to the target value being the node attribute; or in response to the target value being the storage location information, based on the storage location information, an edge attribute corresponding to the target key can be determined in the second data block included in the SSTable file, and the edge attribute corresponding to the target key can be determined as a graph query result.

According to the above manner, a key-value storage system is configured by using characteristics of a graph topology and a graph query. For example, the key-value storage system is adjusted and improved in terms of a format of the SSTable file, an indexing manner, etc., so that the SSTable file used to store graph data in the key-value storage system is graph-aware. This can reduce complexity of a graph query operation, in the key-value storage system, of a graph storage engine constructed based on the key-value storage system, and improve graph query efficiency, thereby ensuring that the graph storage engine has relatively efficient graph query performance.

Corresponding to the above implementations of the above method, the present application further provides an implementation of an apparatus.

FIG. 4 is a schematic structural diagram illustrating a device according to an example implementation of the present application. In terms of hardware, the device includes a processor 402, an internal bus 404, a network interface 406, a memory 408, and a non-volatile memory 410, and certainly may further include other hardware. One or more implementations of the present application can be implemented in a software-based manner. For example, the processor 402 reads a corresponding computer program from the non-volatile memory 410 into the memory 408, and then runs the computer program. Certainly, in addition to a software implementation, one or more implementations of the present application do not exclude another implementation, for example, a logic device or a combination of hardware and software. For example, an execution body of the following processing procedure is not limited to each logical module, and can be hardware or a logic device.

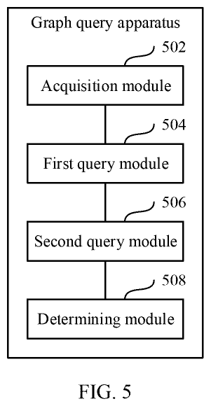

FIG. 5 is a block diagram illustrating a graph query apparatus according to an example implementation of the present application.

The graph query apparatus can be used in the device shown in FIG. 5, to implement the technical solutions of the present application. A node and an edge in a graph are stored in a sorted string table (SSTable) file; the SSTable file includes at least one first data block used to store a key-value pair corresponding to the node and the edge, and a second data block used to store an edge attribute of the edge; the node and the edge are respectively represented by a first key-value pair and a second key-value pair, and are stored in the first data block; in the first key-value pair, a key includes a node identifier of the node, and a value includes a node attribute of the node; in the second key-value pair, a key includes a start identifier and a destination identifier of the edge, and a value includes storage location information of the edge attribute of the edge in the SSTable file; and each target first key-value pair, and a target second key-value pair whose start identifier is the same as a node identifier in the target first key-value pair are aggregated and stored in the first data block.

The graph query apparatus can include: an acquisition module 502, configured to obtain a target key used to query the graph; a first query module 504, configured to query the SSTable file based on a target node identifier in the target key, to determine a target first data block used to aggregate and store a first key-value pair and a second key-value pair that include the target node identifier; a second query module 506, configured to query the target first data block based on the target key, to determine a target value corresponding to the target key; and a determining module 508, configured to: determine the node attribute as a graph query result in response to the target value being the node attribute; or in response to the target value being the storage location information, based on the storage location information, determine an edge attribute corresponding to the target key in the second data block included in the SSTable file, and determine the edge attribute corresponding to the target key as a graph query result.

In some implementations, the SSTable file further includes a first-level index created based on the node identifier in the first key-value pair, and the first-level index is used to indicate a first data block in which the first key-value pair and the second key-value pair that include each node identifier are located.

The querying the SSTable file based on the target node identifier in the target key, to determine the target first data block used to aggregate and store the first key-value pair and the second key-value pair that include the target node identifier includes: querying the first-level index included in the SSTable file based on a target node identifier in the target key, to determine a target first data block used to aggregate and store a first key-value pair and a second key-value pair that include the target node identifier.

In some implementations, the SSTable file is an SSTable file in a log structured merge tree (LSM-Tree).

The apparatus further includes: a third query module, configured to: before the SSTable file is queried based on the target node identifier in the target key, query the LSM-Tree based on the target key, to determine the SSTable file used to store a key-value pair including the target key.

In some implementations, a data amount of the first key-value pair and the second key-value pair stored in each first data block is not greater than a predetermined threshold, and the target first key-value pair and the target second key-value pair are aggregated and stored in one or a plurality of consecutive first data blocks.

In some implementations, when the target first key-value pair and the target second key-value pair are aggregated and stored in the plurality of consecutive first data blocks, the first first data block in the plurality of consecutive first data blocks is further used to store a second-level index created based on a key in the target second key-value pair, the second-level index is used to indicate the first data block in which the target second key-value pair is located, and the first-level index is used to indicate the first first data block in which the first key-value pair and the second key-value pair that include each node identifier are located.

The determining module 508 is further configured to: in response to the target value being the second-level index, query the second-level index based on the target key, to determine a first data block corresponding to the target key; query the first data block corresponding to the target key based on the target key, to determine a value corresponding to the target key; and determining a graph query result based on the value corresponding to the target key. For example, storage location information corresponding to the target key is determined; and based on the storage location information corresponding to the target key, determine an edge attribute corresponding to the target key in the second data block included in the SSTable file, and determine the edge attribute corresponding to the target key as a graph query result.

In some implementations, the second-level index includes a key range of a target second key-value pair in each first data block included in the plurality of consecutive first data blocks, and a correspondence with storage location information of the first data block in the SSTable file; and the querying the second-level index based on the target key, to determine the first data block corresponding to the target key includes: performing a binary search in the second-level index based on the target key, to determine storage location information of the first data block corresponding to the target key in the SSTable file, and determining the first data block corresponding to the target key in the SSTable file based on the storage location information.

In some implementations, the first-level index includes each node identifier, and a correspondence with storage location information, in the SSTable file, of the first first data block in which the first key-value pair and the second key-value pair that include the node identifier are located; and the correspondence in the first-level index is arranged based on a sequence of the first key-value pair in the first data block; and the querying the first-level index included in the SSTable file based on the target node identifier in the target key, to determine the target first data block used to aggregate and store the first key-value pair and the second key-value pair that include the target node identifier includes: querying, based on the target node identifier in the target key, the first-level index included in the SSTable file, to determine a target correspondence including the target node identifier, and a next correspondence of the target correspondence; and determining, in the SSTable file as the target first data block used to aggregate and store the first key-value pair and the second key-value pair that include the target node identifier, a first data block within a range from a first data block indicated by storage location information included in the target correspondence to a first data block indicated by storage location information included in the next correspondence.

In some implementations, when a subgraph including the node and the edge corresponding to the key-value pair stored in the SSTable file is a sparse subgraph, the first-level index in the SSTable file is an index block in the SSTable file; or when a subgraph including the node and the edge corresponding to the key-value pair stored in the SSTable file is a dense subgraph, the first-level index in the SSTable file is a hash index.

In some implementations, the key in the first key-value pair further includes a node type of the node.

In some implementations, the key in the second key-value pair further includes a start type of the edge and/or an establishment timestamp of the edge.

Because the apparatus implementation basically corresponds to the method implementation, for related parts, references can be made to related descriptions in the method implementation. The apparatus implementation described above is merely an example. The modules described as separate parts may or may not be physically separate, and parts displayed as modules may or may not be physical modules, e.g., can be located in one place, or can be distributed on a plurality of network modules. Some or all of the modules can be selected based on an actual requirement, to achieve objectives of the technical solutions of the present application.

The systems, apparatuses, modules, or units described in the above implementations can be implemented by a computer chip or an entity, or can be implemented by a product having a certain function. A typical implementation device is a computer, and a form of the computer can be a personal computer, a laptop computer, a cellular phone, a camera phone, a smartphone, a personal digital assistant, a media player, a navigation device, an email receiving/sending device, a game console, a tablet computer, a wearable device, or any combination of several devices in these devices.

In a typical configuration, the computer includes one or more processors (CPU), an input/output interface, a network interface, and one or more memory devices. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively. The one or more memory devices may be configured to individually or collectively store computer executable instructions to enable the methods provided herein to be implemented. When the one or more memory devices collectively store computer executable instructions, they may or may not store the same instruction or same part of an instruction at a same time and they may store different instructions or different parts of an instruction collectively.

The memory can include a non-persistent storage, a random access memory (RAM), a non-volatile memory, and/or another form in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic disk storage, a quantum storage, a graphene-based storage medium, another magnetic storage device, or any other non-transmission medium. The computer storage medium can be configured to store information that can be accessed by a computing device. As described in the present specification, the computer-readable medium does not include computer-readable transitory media such as a modulated data signal and a carrier.

It should also be noted that the terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by “includes a . . . ” does not preclude the existence of additional identical elements in the process, method, product, or device that includes the element.

Example implementations of the present application are described above. Other implementations fall within the scope of the present application. In some cases, the actions or steps recorded in the present application can be performed in an order different from that in the implementations and the desired results can still be achieved. In addition, the process depicted in the accompanying drawings does not necessarily require the shown particular order or sequence to achieve the desired results. In some implementations, multi-tasking and parallel processing are feasible or may be advantageous.

The terms used in one or more implementations of the present application are merely used to describe example implementations, and are not intended to limit the one or more implementations of the present application. The terms “a”, “said”, and “the” of singular forms are also intended to include plural forms, unless otherwise specified in the context clearly. The term “and/or” indicates and includes any or all possible combinations of one or more associated listed items.

In one or more implementations of the present application, descriptions such as “one implementation”, “some implementations”, “examples”, “specific examples”, or “an implementation” mean that specific features or characteristics described with reference to the implementations are included in at least one implementation of the present application. Illustrative descriptions of these terms do not necessarily have to be specific to the same implementation. In addition, the described specific features or characteristics can be combined in a proper manner in one or more implementations of the present application. In addition, without contradicting each other, different implementations and specific features or characteristics within different implementations can be combined.

It should be understood that although the terms such as “first”, “second”, and “third” may be used in one or more implementations of the present application to describe various types of information, the information should not be limited to these terms. These terms are merely used to distinguish between information of the same type. For example, without departing from the scope of one or more implementations of the present application, first information can also be referred to as second information, and similarly, the second information can also be referred to as the first information. Depending on the context, for example, the word “if” used here can be explained as “while”, “when”, or “in response to determining”.

The above descriptions are merely example implementations of one or more implementations of the present application, but are not intended to limit the one or more implementations of the present application. Any modification, equivalent replacement, improvement, etc. made without departing from the spirit and principle of the one or more implementations of the present application shall fall within the protection scope of the one or more implementations of the present application.

User information (including but not limited to device information of a user, personal information of a user, etc.) and data (including but not limited to data used for analysis, stored data, displayed data, etc.) used in the present application are information and data that are authorized by the user or fully authorized by each party, related data is collected, used, and processed by abiding by related laws and regulations and standards of a related country and region, and a corresponding operation entry is provided, so that the user chooses to perform authorization or rejection.

What is claimed is:

1. A graph database system, comprising:
a storage space having a sorted string table (SSTable) file stored therein, the SSTable file including at least one first data block used to store a key-value pair corresponding to a node and an edge of a graph data, and a second data block used to store an edge attribute of the edge;
wherein the key-value pair includes a first key-value pair and a second key-value pair, in the first key-value pair, a key including a node identifier of the node, and a value including a node attribute of the node, and in the second key-value pair, a key including a start identifier and a destination identifier of the edge, and a value including storage location information of the edge attribute of the edge in the SSTable file; and
wherein the first data block includes a target first key-value pair and a target second key-value pair, the target second ley-value pair including a start identifier that is same as a node identifier in the target first key-value pair.

2. The graph database system according to claim 1, wherein the SSTable file includes a first-level index related to the node identifier in the first key-value pair, and the first-level index is used to indicate a first data block in which the first key-value pair and the second key-value pair are located.

3. The graph database system according to claim 1, wherein the storage space has a log structured merge tree (LSM-Tree) stored therein, and the SSTable file is an SSTable file in the LSM-Tree.

4. The graph database system according to claim 2, wherein a data amount of the first key-value pair and the second key-value pair stored in a first data block is not greater than a first threshold, and the target first key-value pair and the target second key-value pair are aggregated and stored in a plurality of consecutive first data blocks.

5. The graph database system according to claim 4, wherein a first first data block in the plurality of consecutive first data blocks further stores a second-level index created based on a key in the target second key-value pair, the second-level index is used to indicate the first data block in which the target second key-value pair is located, and the first-level index is used to indicate the first first data block in which the first key-value pair and the second key-value pair that include each node identifier are located.

6. The graph database system according to claim 5, wherein the second-level index includes a key range of a target second key-value pair in each first data block included in the plurality of consecutive first data blocks, and a correspondence with storage location information of the first data block in the SSTable file.

7. The graph database system according to claim 5, wherein the first-level index includes each node identifier, and a correspondence with storage location information, in the SSTable file, of the first first data block in which the first key-value pair and the second key-value pair that include the node identifier are located; and
the correspondence in the first-level index is arranged based on a sequence of the first key-value pair in the first data block.

8. The graph database system according to claim 2, wherein when a subgraph including the node and the edge corresponding to the key-value pair stored in the SSTable file is a sparse subgraph, the first-level index in the SSTable file is an index block in the SSTable file; and
when a subgraph including the node and the edge corresponding to the key-value pair stored in the SSTable file is a dense subgraph, the first-level index in the SSTable file is a hash index.

9. A method for querying a graph, the graph including a node and an edge stored in a sorted string table (SSTable) file; the SSTable file including at least one first data block used to store a key-value pair corresponding to the node and the edge, and a second data block used to store an edge attribute of the edge, the node and the edge being respectively represented by a first key-value pair and a second key-value pair, and being stored in the first data block, in the first key-value pair, a key including a node identifier of the node, and a value including a node attribute of the node, in the second key-value pair, a key including a start identifier and a destination identifier of the edge, and a value including storage location information of the edge attribute of the edge in the SSTable file, and a target first key-value pair and a target second key-value pair whose start identifier is a same as a node identifier in the target first key-value pair being aggregated and stored in the first data block; and
the method comprising:
obtaining a target key used to query the graph;
querying the SSTable file based on a target node identifier in the target key, to determine a target first data block used to aggregate and store a first key-value pair and a second key-value pair that include the target node identifier; and
querying the target first data block based on the target key, to determine a graph query result based on a target value corresponding to the target key.

10. The method of claim 9, wherein the determine the graph query result includes:
determining the node attribute as the graph query result in response to the target value being the node attribute; and
in response to the target value being the storage location information, based on the storage location information, determining an edge attribute corresponding to the target key in the second data block included in the SSTable file, and determining the edge attribute corresponding to the target key as the graph query result.

11. The method according to claim 9, wherein the SSTable file further includes a first-level index related to the node identifier in the first key-value pair, and the first-level index is used to indicate a first data block in which the first key-value pair and the second key-value pair are located; and
the querying the SSTable file based on the target node identifier in the target key, to determine the target first data block used to aggregate and store the first key-value pair and the second key-value pair includes:
querying the first-level index included in the SSTable file based on a target node identifier in the target key, to determine a target first data block used to aggregate and store a first key-value pair and a second key-value pair that include the target node identifier;

12. The method according to claim 9, wherein the SSTable file is in a log structured merge tree (LSM-Tree); and
the method further comprises:
before the querying the SSTable file based on the target node identifier in the target key, querying the LSM-Tree based on the target key, to determine the SSTable file used to store a key-value pair including the target key.

13. The method according to claim 11, wherein a data amount of the first key-value pair and the second key-value pair stored in each first data block is not greater than a first threshold, and the target first key-value pair and the target second key-value pair are aggregated and stored in a plurality of consecutive first data blocks.

14. The method according to claim 13, wherein a first first data block in the plurality of consecutive first data blocks is further used to store a second-level index created based on a key in the target second key-value pair, the second-level index is used to indicate the first data block in which the target second key-value pair is located, and the first-level index is used to indicate the first first data block in which the first key-value pair and the second key-value pair that include each node identifier are located; and
the method further comprises:
in response to the target value being in the second-level index, querying the second-level index based on the target key, to determine a first data block corresponding to the target key;
querying the first data block corresponding to the target key based on the target key, to determine a value corresponding to the target key; and
determining a graph query result based on the value corresponding to the target key.

15. The method according to claim 14, wherein the determining the graph query result based on the value corresponding to the target key includes:
determining storage location information corresponding to the target key; and
based on the storage location information corresponding to the target key, determining an edge attribute corresponding to the target key in the second data block included in the SSTable file, and
determining the edge attribute corresponding to the target key as a graph query result.

16. The method according to claim 14, wherein the second-level index includes a key range of a target second key-value pair in each first data block included in the plurality of consecutive first data blocks, and a correspondence with storage location information of the first data block in the SSTable file; and
the querying the second-level index based on the target key, to determine the first data block corresponding to the target key includes:
performing a binary search in the second-level index based on the target key, to determine storage location information of the first data block corresponding to the target key in the SSTable file, and
determining the first data block corresponding to the target key in the SSTable file based on the storage location information.

17. The method according to claim 11, wherein the first-level index includes each node identifier, and a correspondence with storage location information, in the SSTable file, of the first first data block in which the first key-value pair and the second key-value pair that include the node identifier are located; and the correspondence in the first-level index is arranged based on a sequence of the first key-value pair in the first data block; and
the querying the first-level index included in the SSTable file based on the target node identifier in the target key, to determine the target first data block used to aggregate and store the first key-value pair and the second key-value pair that include the target node identifier includes:
querying, based on the target node identifier in the target key, the first-level index included in the SSTable file, to determine a target correspondence including the target node identifier, and a next correspondence of the target correspondence; and
determining, in the SSTable file as the target first data block used to aggregate and store the first key-value pair and the second key-value pair that include the target node identifier, a first data block within a range from a first data block indicated by storage location information included in the target correspondence to a first data block indicated by storage location information included in the next correspondence.

18. The method according to claim 11, wherein when a subgraph including the node and the edge corresponding to the key-value pair stored in the SSTable file is a sparse subgraph, the first-level index in the SSTable file is an index block in the SSTable file; and
when a subgraph including the node and the edge corresponding to the key-value pair stored in the SSTable file is a dense subgraph, the first-level index in the SSTable file is a hash index.

19. An electronic device, comprising:
one or more processors; and
one or more storage device, individually or collectively, having computer executable instructions stored thereon, the computer executable instructions, when executed by the one or more processors, enabling the one or more processors to, individually or collectively, implement actions including:
obtaining a target key used to query a graph, wherein the graph includes a node and an edge stored in a sorted string table (SSTable) file; the SSTable file including at least one first data block used to store a key-value pair corresponding to the node and the edge, and a second data block used to store an edge attribute of the edge, the node and the edge being respectively represented by a first key-value pair and a second key-value pair, and being stored in the first data block, in the first key-value pair, a key including a node identifier of the node, and a value including a node attribute of the node, in the second key-value pair, a key including a start identifier and a destination identifier of the edge, and a value including storage location information of the edge attribute of the edge in the SSTable file, and a target first key-value pair and a target second key-value pair whose start identifier is a same as a node identifier in the target first key-value pair being aggregated and stored in the first data block;
querying the SSTable file based on a target node identifier in the target key, to determine a target first data block used to aggregate and store a first key-value pair and a second key-value pair that include the target node identifier; and
querying the target first data block based on the target key, to determine a graph query result based on a target value corresponding to the target key.

20. The electronic device of claim 19, wherein the determine the graph query result includes:
determining the node attribute as the graph query result in response to the target value being the node attribute; and
in response to the target value being the storage location information, based on the storage location information, determining an edge attribute corresponding to the target key in the second data block included in the SSTable file, and determining the edge attribute corresponding to the target key as the graph query result.
